(19) United States
(12) Patent Application Publication
(10) Pub. No.: US 2020/0139508 A1
(43) Pub. Date: May 7, 2020

(54) SUCTION HOOD FOR A POWER TOOL

(71) Applicant: Hilti Aktiengesellschaft, Schaan (LI)

(72) Inventor: Oliver OHLENDORF, Landsberg (DE)

(21) Appl. No.: 16/317,858

(22) PCT Filed: Mar. 13, 2017
(86) PCT No.: PCT/EP2017/055779

§ 371 Date: Jan. 16, 2020

(30) Foreign Application Priority Data
Jul. 15, 2016 (EP) 16179675.0

(51) Int. Cl. B24B 55/10; B24B 27/08; B24B 55/05; B25F 5/02; B23Q 11/00

(52) U.S. Cl. CPC B24B 55/102; B24B 27/08; B23Q 11/0046; B25F 5/02; B24B 55/052

(57) ABSTRACT

A suction hood for a power tool, which includes a rotating tool, in particular a grinding or cutting tool, for collecting and removing dust generated during the use of the power tool, a first side wall having a first recess, a second side wall having a second recess, and a suction channel connected to the first and second side walls. The diameter of the first recess is greater than the diameter of a flange of the power tool, so that the first recess is positionable around the flange. The diameter of the second recess is greater than the diameter of a clamping element, which is used to detachably fasten the tool on a spindle of the power tool, so that the clamping element may be accommodated in the second recess. The first and second side walls are positioned at a distance from each other which is shorter than the length of the spindle.

The present invention relates to a suction hood for a power tool, which includes a rotating tool, in particular a grinding or cutting tool, for collecting and removing dust generated during the use of the power tool, a first side wall having a first recess, a second side wall having a second recess, and a suction channel connected to the first and second side walls. The rotating tool may be, for example, a cutting wheel or a grinding wheel.

### BACKGROUND

Grinding or cutting tools, for example angle grinders, usually require a suction hood during their use to collect dust that arises during the use of or when working with the grinding or cutting tool and to conduct it away from the tool (grinding or cutting wheel) or from the workplace. The suction hood may also be referred to as a dust hood or a protective hood.

However, the dust hoods available on the market, i.e. the dust hoods according to the prior art, frequently have a problem both when attaching the dust hood to the power tool and when detaching the dust hood from the power tool. The attachment and detachment may be complicated and laborious for the user of the power tool.

Moreover, replacing the tool, i.e. the grinding or cutting wheel, may present a problem in a power tool which includes a mounted dust hood. Tool changes, i.e. removing the tool from a spindle of the power tool and remounting the tool onto the spindle, may also be complicated and laborious for the user of the power tool.

In addition, the user of the power tool is faced with the often complex task of checking whether the dust hood and/or the tool is/are properly fastened to the power tool.

### SUMMARY OF THE INVENTION

An object of the present invention is to resolve the aforementioned problems or tasks, in particular to provide an improved suction hood for a power tool, which includes a rotating tool, in particular a grinding or cutting tool, with the aid of which the attachment of the dust hood to the power tool and the detachment of the dust hood from the power tool as well as the changing of a tool, e.g. a grinding or cutting tool, are made easier.

The present invention provides a suction hood for a power tool, which includes a rotating tool, in particular a grinding or cutting tool, for collecting and removing dust generated during the use of the power tool, a first side wall having a first recess, a second side wall having a second recess, and a suction channel connected to the first and second side walls.

According to the present invention, it is provided that the diameter of the first recess is greater than the diameter of a flange of the power tool, so that the first recess is positionable around the flange, and the diameter of the second recess is greater than the diameter of a clamping element, which is used to detachably fasten the tool on a spindle of the power tool, so that the clamping element may be accommodated in the second recess, the first and second side walls being positioned at a distance from each other which is shorter than the length of the spindle. The clamping element, for example a clamping nut, may be fastened (e.g. screwed) to the spindle of the power tool from outside the dust hood when the tool (e.g. grinding or cutting wheel) is already in the dust hood. The dust hood may thus be easily and quickly completely fastened to the tool situated in the dust hood from the power tool as well as mounted on the power tool.

According to one advantageous specific embodiment of the present invention, it may be possible that the distance between the first and second side walls essentially corresponds to the width of the tool. The attachment of the clamping element to the spindle of the power tool is additionally facilitated hereby when the dust hood, including the tool situated in the dust hood, is positioned on the power tool.

Other advantages result from the following description of the figures. The figures illustrate different exemplary embodiments of the present invention. The figures, the description and the claims contain numerous features in combination. Those skilled in the art will advantageously also consider the features individually and combine them to form other meaningful combinations.

### BRIEF DESCRIPTION OF THE DRAWINGS

In the figures, identical and equivalent components are provided with identical reference numerals.

FIG. 1 shows a perspective view of a suction hood according to the present invention, including an indicated power tool in the form of an angle grinder and a tool in the form of a cutting wheel in a detached state;

FIG. 2 shows another perspective view of the suction hood, together with the angle grinder and the cutting wheel in a detached state;

FIG. 3 shows another perspective view of the suction hood, the cutting wheel being positioned in the suction hood, and the suction hood being positioned above the angle grinder counter to arrow direction R;

FIG. 4 shows another perspective view of the suction hood, the cutting wheel being positioned in the suction hood, and the suction hood being positioned on the angle grinder;

FIG. 5 shows another perspective view of the suction hood in a mounted state.

### DETAILED DESCRIPTION

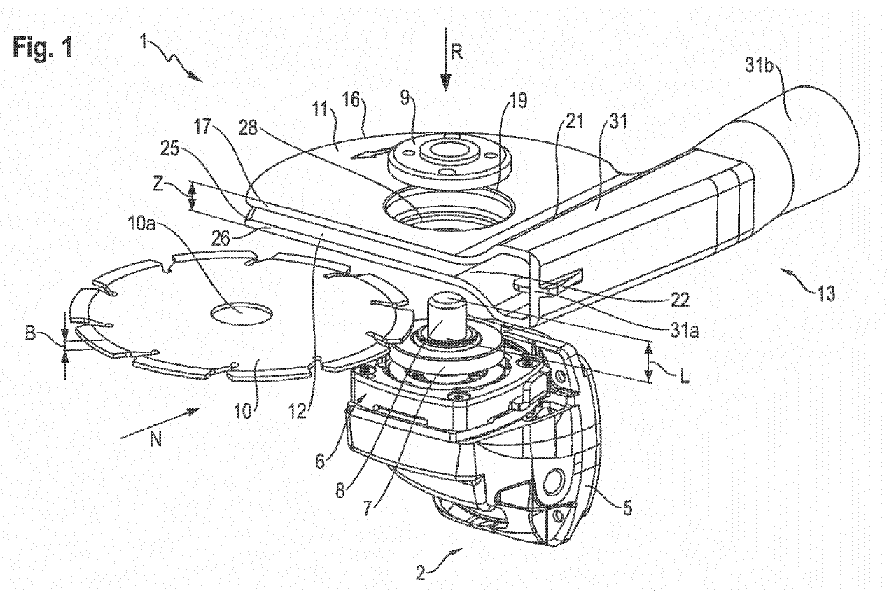

FIG. 1 shows a suction hood 1 according to the present invention for a power tool 2 in a state detached from power tool 2. Suction hood 1 may also be referred to as a dust hood or a protective hood.

Power tool 2 is an angle grinder. Only a head 5 of the angle grinder, including a tool holder 6, is visible in the figures.

Tool holder 6 contains a spindle 8 for fastening a tool 10, for example a grinding or cutting wheel, as well as for transmitting a torque to tool 10. Spindle 8 has a length L.

Tool 10 contains a central through-bore 10a and may be fastened thereto with the aid of a clamping element 9 on spindle 8. Tool 10 has a width B. Clamping element 9 is illustrated in the figures as a clamping nut and may be screwed to spindle 8. Spindle 8 is rotatably connected to head 5 of power tool 2 with the aid of a flange 7. Flange 7 is positioned on head 5 of power tool 2 beneath spindle 8 in arrow direction R.

Dust hood 1 essentially includes a first side wall 11, a second side wall 12 and a suction channel 13.

First side wall 11 essentially has a first curved side edge 16, a first straight side edge 21, a first base edge 17 and a first recess 19.

Second side wall 12 essentially has a second curved side edge 25, a second straight side edge 22, a second base edge 26 and a second recess 28. First and second side edges 11, 12 are connected to each other via a limiting wall 27 and have a distance Z from each other. Distance Z is measured from a point on first side wall 11 to a corresponding point on second side wall 12. The distance may be measured from the outer surface of first side wall 11 to the outer surface of second side wall 12. Limiting wall 27 runs along first and second curved side edges 16, 25. First and second base edges 17, 26 are used to guide suction hood 1 along a workpiece to be processed.

First recess 19 of first side wall 11 is larger than the diameter of flange 7 of power tool 2, so that first recess 19 may be positioned around flange 7. The diameter of first recess 19 and the diameter of flange 7 are dimensioned in such a way that first recess 19 may be placed against flange 7 to form an accurate fit. Second recess 28 of second side wall 12 is larger than the diameter of clamping element 9 designed as a clamping nut, so that clamping nut 9 may be accommodated in second recess 28. It is also possible that the diameter of first recess 19 is only slightly greater than the diameter of flange 7, so that first recess 19 preferably closely abuts flange 7. The diameter of second recess 28 and the diameter of clamping nut 9 are dimensioned in such a way that clamping nut 9 may be placed against second recess 28 to form an accurate fit. It is also possible that the diameter of second recess 28 is only slightly greater than the diameter of clamping nut 9, so that second recess 28 preferably closely abuts clamping nut 9.

Suction channel 13 essentially contains a cylindrical chute 31, which has a first end 31a and a second end 31b. First end 31a forms a shared plane with first and second base edges 17, 26. A hose may be fastened to second end 31b, which, in turn, is connected to a vacuum cleaner. Neither the hose nor the vacuum cleaner is illustrated in the figures. First straight side edge 21 of first side wall 11 and second straight side edge 22 of second side wall 12 are connected to chute 31 of suction channel 13, so that a cavity between first and second side walls 11, 12 is connected to a cavity within suction channel 13. By connecting the cavities, dust which arises during the processing of a workpiece by tool 10 may be conducted through the two side walls 11, 12 and into chute 31 of suction channel 13 when a vacuum cleaner is connected to suction hood 1.

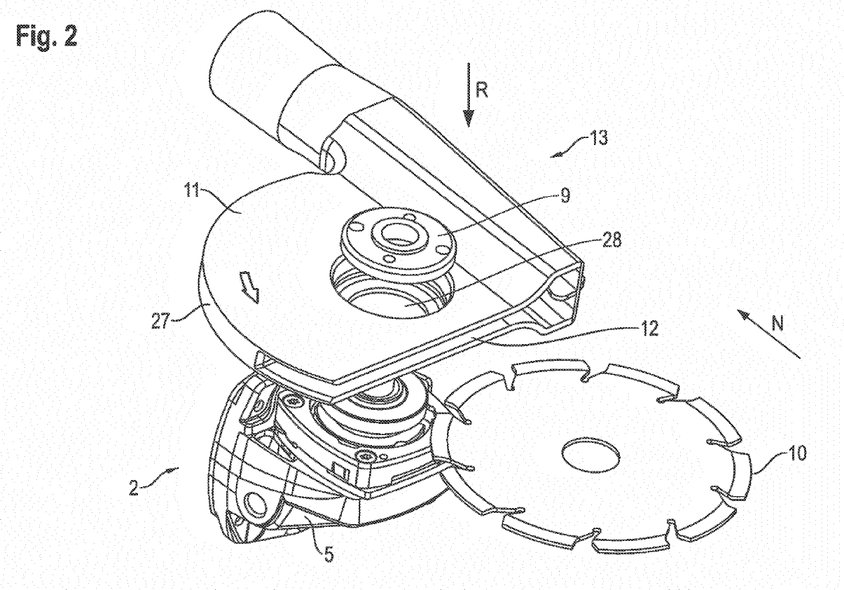

The mounting of tool 10 in the form of a cutting wheel onto power tool 2 in the form of an angle grinder, including a suction hood 1 according to the present invention, is illustrated in FIGS. 2 through 5.

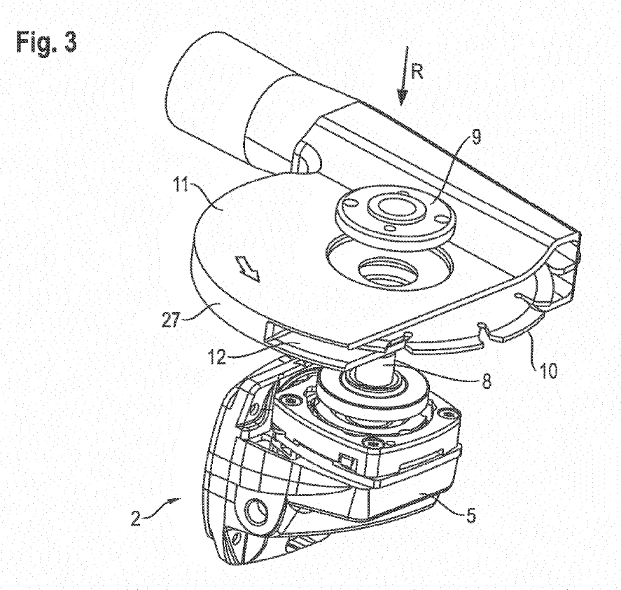

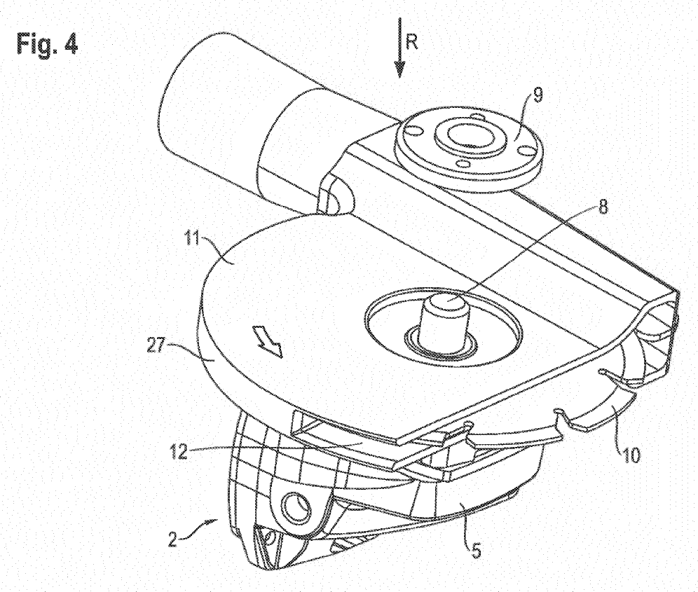

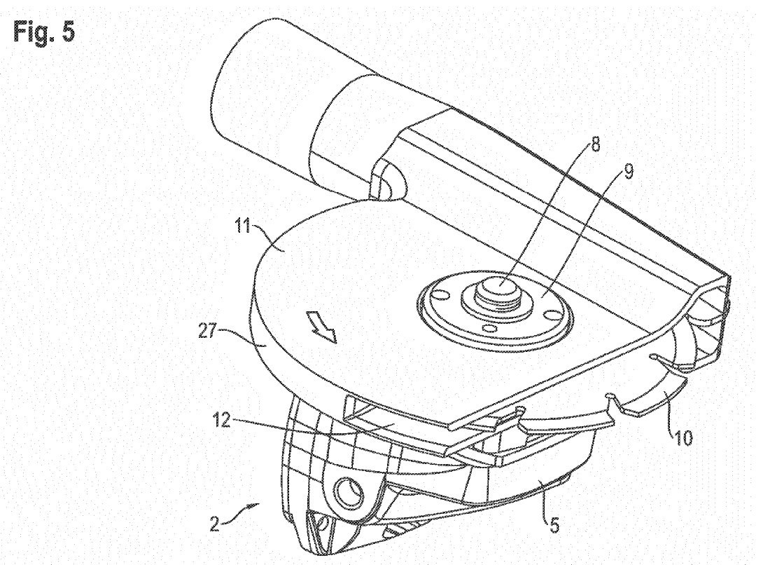

As described in FIG. 2, suction hood 1 is detached from angle grinder 2. Clamping element 9 illustrated as a clamping nut is detached from spindle 8. Cutting wheel 10 is inserted into the cavity between first and second side walls 11, 12 in arrow direction N. As illustrated in the figure, cutting wheel 10 is inserted into the cavity until through-bore 10a of tool 10 designed as a cutting wheel is flush with first recess 19 of first side wall 11 and second recess 28 of second side wall 12 (cf. FIG. 3). Suction hood 1 is subsequently positioned on spindle 8 of angle grinder 2 together with cutting wheel 10. Spindle 8 protrudes through suction hood 1, due to short distance Z of side walls 11, 12 from each other. Clamping nut 9 is fastened to spindle 8 in arrow direction R (cf. FIG. 4). By fastening clamping nut 9 to spindle 8, tool 10 and suction hood 1 are connected to head 5 of power tool 2 (cf. FIG. 5).

1-2. (canceled)

3. A suction hood for a power tool including a rotating tool, the suction hood for collecting and removing dust generated during use of the power tool, the suction hood comprising:
a first side wall having a first recess;
a second side wall having a second recess; and
a suction channel connected to the first and second side walls, a first diameter of the first recess being greater than a diameter of a flange of the power tool, so that the first recess is positionable around the flange, and a second diameter of the second recess being greater than a clamping element diameter of a clamping element used to detachably fasten the tool on a spindle of the power tool, so that the clamping element is accommodatable in the second recess, the first and second side walls being positioned at a distance from each other, the distance being shorter than a length of the spindle.

4. The suction hood as recited in claim 3 wherein the distance corresponds to a width of the tool.

5. A grinding or cutting tool comprising the suction hood as recited in claim 3.
